(19) United States
(12) Patent Application Publication
(10) Pub. No.: US 2010/0209604 A1
(43) Pub. Date: Aug. 19, 2010

(54) ROTARY LINER, AND CONVEYING ASSEMBLY AND METHOD THEREFOR

(76) Inventor: DENNIS CORNELIUS STAMMEN, Vandalia, OH (US)

Correspondence Address: ECKERT SEAMANS CHERIN & MELLOTT, 600 GRANT STREET, 44TH FLOOR, PITTSBURGH, PA, 15219, US

(21) Appl. No.: 12/371,994

(22) Filed: Feb. 17, 2009

(51) Int. Cl. B05D 5/10; B65G 21/00; B05C 13/00

(52) U.S. Cl. 427/207.1; 198/861.1; 118/503

(57) ABSTRACT

A conveying assembly is provided for conveying container closures, such as can ends or lids, to and from a rotary liner. The rotary liner includes a base, a chuck assembly and a turret assembly. The turret assembly includes a number of fluid dispensing apparatus to dispense a sealant for lining the can ends. The chuck assembly includes chuck members for manipulating the can ends to facilitate the application of the sealant. The conveying assembly includes a plurality of downstackers for feeding the can ends into the rotary liner, a plurality of star wheels, and a number of unloading guides. Each star wheel transfers can ends from a corresponding one of the downstackers to the chuck assembly. The unloading guides cooperate with the chuck assembly to discharge the can ends from the rotary liner. An associated method of lining can ends is also disclosed.

### BACKGROUND

1. Field

The disclosed concept relates generally to machinery for container closures and, more particularly to rotary liners and methods for lining container closures such as, for example, can ends, with a sealant material. The disclosed concept also relates to conveying assemblies for rotary liners.

2. Background Information

It is known to apply sealant material, commonly referred to as compound, to the underside of container closures to facilitate subsequent sealing attachment (e.g., without limitation, seaming) of the closures to containers such as, for example, beverage and food cans.

FIGS. 1A and 1B, for example, show a container closure 1, commonly referred to as a can lid or can end, for sealing the open end of a can 3 (e.g., without limitation, a beer or beverage can; a food can). During the manufacture of the can end 1, sealant material 5 (e.g., compound) is applied in an annular pattern on the underside 7 of the curl region 9 of the can end 1, as shown in FIG. 1A. As shown in FIG. 1B, after the can 3 has been filled, the can end 1 is seamed onto an upper flange 11 of the can 3. The previously applied sealant material 5 is disposed between the curl region 9 of the end 1 and the upper flange 11 of the can 3 to provide an effective seal therebetween.

FIGS. 2-4 show an example rotary liner 13, which is used to apply sealant 5 (FIGS. 1A and 1B) to can ends 1 (shown in phantom line drawing in FIGS. 2-4) in relatively high volume applications. The rotary liner 13 generally includes a base 15 having a chuck assembly 17. As shown in FIG. 2, a pivotal turret assembly 19 is disposed over the chuck assembly 17 and includes a number of peripherally disposed fluid dispensing apparatus 21 (e.g., sealant or compound guns). A single downstacker 23 (FIG. 2) delivers the can ends 1 to a single star wheel 25 (best shown in FIG. 3; partially shown in FIG. 4) which, in turn, cooperates with corresponding chuck members 27 of the chuck assembly 17 to support and rotate the can ends 1 relative to the fluid dispensing apparatus 21 (FIG. 2). Specifically, the star wheel 25 rotates the can ends 1 onto the chuck members 27, which are raised by cams to receive the can ends 1. The chuck members 27 then begin to rotate the can ends 1, which is commonly referred to as “pre-spin”. Once the can ends 1 reach the desired rotational velocity, the sealant 5 (FIGS. 1A and 1B) is applied (e.g., without limitation, sprayed onto) to the can ends 1 by the fluid dispensing apparatus 21. In this manner, the sealant 5 (FIGS. 1A and 1B) is evenly applied. This is commonly referred to as the “spray time.” After the sealant 5 (FIGS. 1A and 1B) is applied, the can ends 1 continue to be rotated for a relatively brief period of time to smooth out the sealant 5. This is commonly referred to as the “post spin time.” Finally, the cams lower the chuck members 27 and can ends 1, and each can end 1 is removed and discharged from the rotary liner 13 via an unloading guide 29, as shown in FIG. 3.

Accordingly, the aforementioned rotary liner 13 results in a single distinct pathway 31 for conveying can ends 1 into and out of the rotary liner 13, as shown in FIGS. 3 and 4. Among other disadvantages with the above design is that the relatively high rotational speed of the single star wheel 25 can impose excessive force on the can ends 1, causing them to deform (e.g., dent; bend). Additionally, only eight can ends 1 are lined for every revolution (e.g., 360 rotation) of the turret assembly 19. It is, therefore, also desirable to increase productivity of the rotary liner 13.

There is, therefore, room for improvement in rotary liners, and in conveying assemblies and methods therefor.

### SUMMARY

These needs and others are met by embodiments of the disclosed concept, which are directed to a conveying assembly and associated method for increasing the productivity of a rotary liner.

As one aspect of the disclosed concept, a conveying assembly is provided for conveying container closures to and from a rotary liner. The rotary liner includes a base, a chuck assembly and a turret assembly. The turret assembly includes a number of fluid dispensing apparatus structured to dispense a sealant for lining the container closures. The chuck assembly comprises a plurality of chuck members structured to manipulate the container closures with respect to the fluid dispensing apparatus to facilitate the application of the sealant. The conveying assembly comprises: a plurality of downstackers structured to feed the container closures into the rotary liner; a plurality of star wheels each being structured to transfer a number of the container closures from a corresponding one of the downstackers to the chuck assembly; and a number of unloading guides structured to cooperate with the chuck assembly to discharge the container closures from the rotary liner.

The plurality of downstackers may be a first downstacker and a second downstacker, and the plurality of star wheels may be a first star wheel and a second star wheel. The first star wheel may be structured to transfer each of the container closures from the first downstacker to a corresponding one of the chuck members of the chuck assembly, and the second star wheel may be structured to transfer each of the container closures from the second downstacker to another corresponding one of the chuck members of the chuck assembly. The turret assembly may rotate about an axis, wherein a plurality of container closures are lined with the sealant during each revolution of the turret assembly about the axis As another aspect of the disclosed concept, a rotary liner is provided. The rotary liner comprises: a base including a first side and a second side; a turret assembly including a number of fluid dispensing apparatus structured to dispense a sealant for lining a plurality of container closures; a chuck assembly comprising a plurality of chuck members for manipulating the container closures with respect to the fluid dispensing apparatus to facilitate the application of the sealant; and a conveying assembly for conveying the container closures to and from the rotary liner, the conveying assembly comprising: a plurality of downstackers for feeding the container closures into the rotary liner, a plurality of star wheels each transferring a number of the container closures from a corresponding one of the downstackers to corresponding chuck members of the chuck assembly, and a number of unloading guides cooperating with the chuck assembly to discharge the container closures from the first side of the base of the rotary liner and the second side of the base of the rotary liner.

In a further aspect of the disclosed concept, a method of lining container closures in a rotary liner is provided. The method comprises: providing a conveying assembly including a first downstacker, a second downstacker, a first star wheel and a second star wheel; feeding a number of container closures from the first downstacker and a number of container closures from the second downstacker into the rotary liner; transferring each of the container closures from the first downstacker to a corresponding chuck member of a chuck assembly of the rotary liner using the first star wheel; transferring each of the container closures from the second downstacker to another corresponding chuck member of the chuck assembly using the second star wheel; rotating a turret assembly of the rotary liner about an axis and dispensing a sealant as the turret assembly rotates; lining a plurality of container closures from the first downstacker and a plurality of container closures from the second downstacker with the sealant during a single revolution of the turret assembly about the axis; and discharging the container closures from a number of unloading guides of the rotary liner.

### BRIEF DESCRIPTION OF THE DRAWINGS

A full understanding of the disclosed concept can be gained from the following description of the preferred embodiments when read in conjunction with the accompanying drawings in which:

FIG. 1A is a side elevation view of a section of a can end showing the placement of sealant prior to the can end being seamed to a can;

FIG. 1B is a side elevation view of a section of the can end and can of FIG. 1A modified to show the can end after being seamed to the can;

FIG. 2 is an isometric view of a rotary liner;

FIG. 3 is a top plan view of the rotary liner of FIG. 2 with the turret assembly and downstacker removed to show hidden features;

FIG. 4 is an enlarged top plan view of the rotary liner of FIG. 3, showing the chuck assembly and conveyance pathway of the can ends;

FIG. 5 is an isometric view of a rotary liner, in accordance with an embodiment of the disclosed concept;

FIG. 6 is a top plan view of the rotary liner of FIG. 5 with the turret assembly and downstackers removed to show hidden features; and

FIG. 7 is an enlarged top plan view of the rotary liner of FIG. 6, showing the chuck assembly and can end conveyance pathways in accordance with the disclosed concept.

### DESCRIPTION OF THE PREFERRED EMBODIMENTS

Directional phrases used herein, such as, for example, left, right, up, down, top, bottom, clockwise, counterclockwise and derivatives thereof, relate to the orientation of the elements shown in the drawings and are not limiting upon the claims unless expressly recited therein.

The specific elements illustrated in the drawings and described herein are simply exemplary embodiments of the disclosed concept. Accordingly, specific dimensions, orientations and other physical characteristics related to the embodiments disclosed herein are not to be considered limiting on the scope of the disclosed concept.

As employed herein, the terms “container closure,” “can end” and “lid” are generally synonymous and are used substantially interchangeably to refer to any known or suitable closure member that is applied to (e.g., with limitation, seamed to) the open end of a container (e.g., without limitation, beverage can; food can) to seal the contents of the container therein.

As employed herein, the term “productivity” refers to the output of the rotary liner and is preferably measured in container closures per minute.

As employed herein, the statement that two or more parts are “coupled” together shall mean that the parts are joined together either directly or joined through one or more intermediate parts.

As employed herein, the term “number” shall mean one or an integer greater than one (i.e., a plurality).

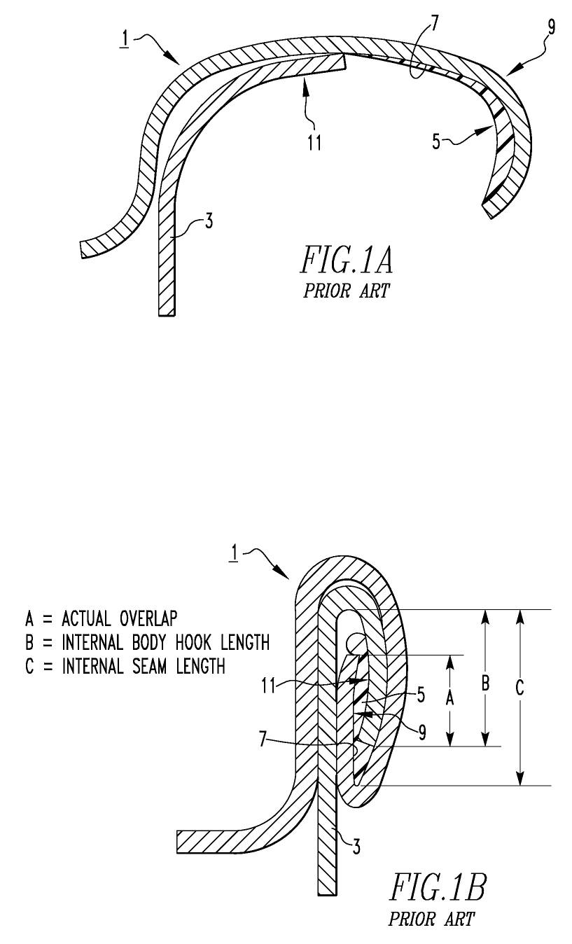

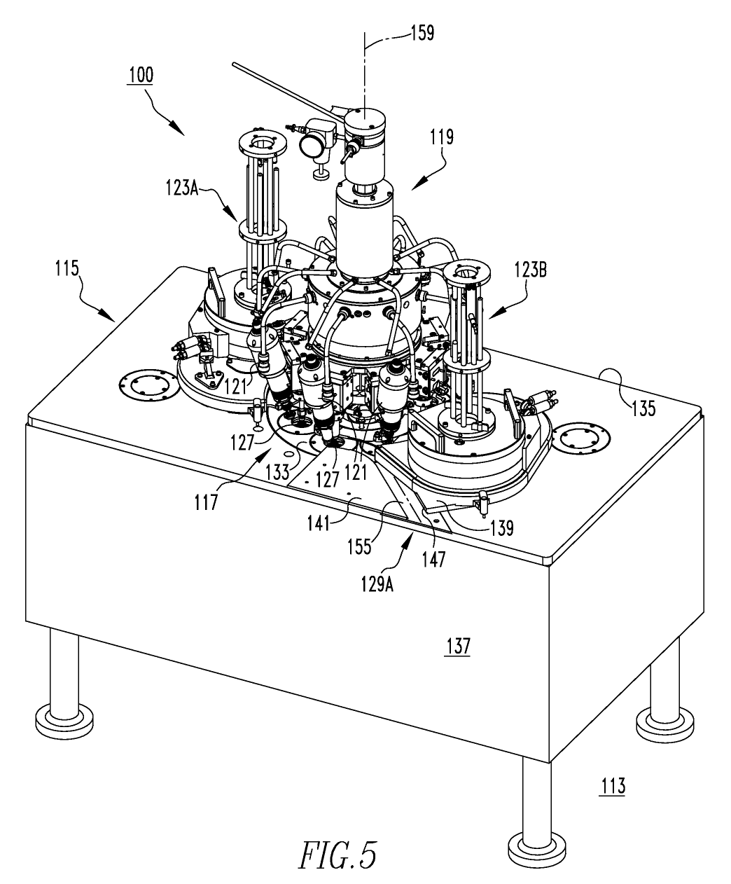

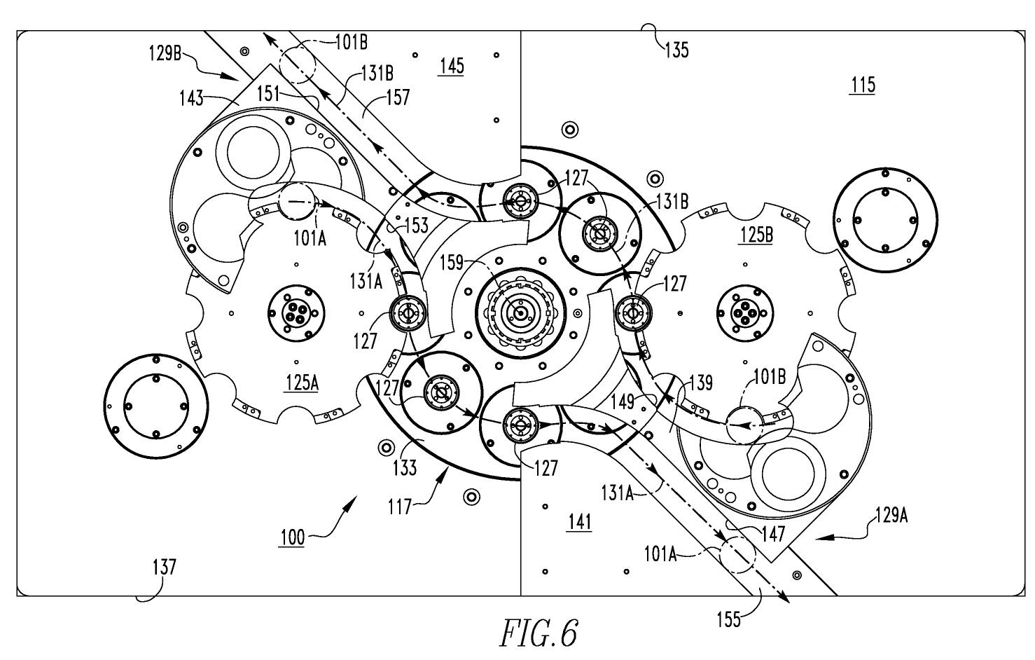

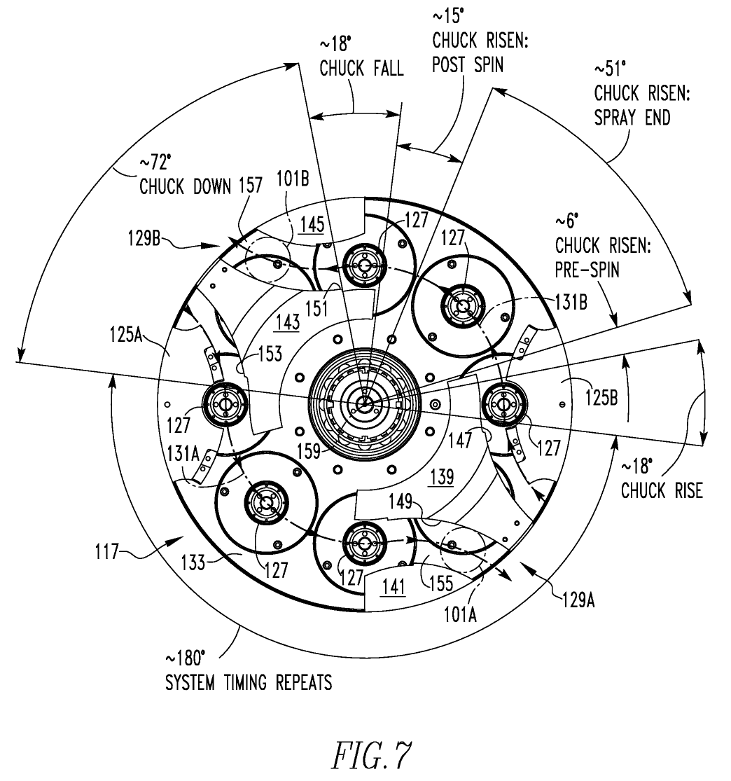

FIG. 5 shows a conveying assembly 100 for conveying container closures such as, for example, the can ends 101A,101B shown in phantom line drawing in FIGS. 6 and 7, to and from a rotary liner 113. The rotary liner 113 includes a base 115, a chuck assembly 117 (partially shown in FIG. 5; see also FIGS. 6 and 7) and a turret assembly 119. The turret assembly 119 includes a number of fluid dispensing apparatus 121 (e.g., without limitation, sealant or compound dispensing guns) structured to dispense a sealant (see, for example, sealant 5 previously discussed hereinabove with respect to FIGS. 1A and 1B) into the curl region (see, for example, curl region 9, shown in FIGS. 1A and 1B) of the can ends 101A,101B (FIGS. 6 and 7), prior to the can ends 101A,101B (FIGS. 6 and 7) being discharged from the rotary liner 113 and seamed to a suitable container (see, for example, the beverage or a food can of FIGS. 1A and 1B). Rotary liners and fluid dispensing systems therefor are further described, for example, in commonly assigned U.S. Pat. No. 6,547,878, which is hereby incorporated herein by reference.

As shown in FIGS. 6 and 7, the chuck assembly 117 of the example rotary liner 113 includes a plurality of chuck members 127, sometimes referred to as lifting chucks, which are structured to manipulate (e.g., without limitation, raise and lower; rotate clockwise and/or counter clockwise) the can ends 101A,101B with respect to the fluid dispensing apparatus 121 (FIG. 5), to facilitate the application of the sealant, and the can end lining process in general. The chuck members 127 are disposed on a generally planar member 133 of the chuck assembly 117, which in the example shown and described herein is a circular member that is pivotable (e.g., counterclockwise with respect to FIGS. 6 and 7) with respect to the base 115 of the rotary liner 113.

The conveying assembly 100 preferably includes a first downstacker 123A and a second downstacker 125B, both shown in FIG. 5, and a first star wheel 125A and a second star wheel 125B, both shown in FIG. 6 (also partially shown in FIG. 7). In operation, the first downstacker 123A feeds can ends 101A into the rotary liner 113 by way of the first star wheel 125A, and the second downstacker 123B feeds can ends 101B into the rotary liner 113 by way of the second star wheel 125B. More specifically, the first star wheel 125A is structured to transfer each of the can ends 101A from the first downstacker 123A to a corresponding one of the chuck members 127 of the chuck assembly 117. Similarly, second star wheel 125B transfers each can end 101B from the second downstacker 123B to another, different corresponding one of the chuck members 127 of the chuck assembly 117, as shown in FIG. 6. A number of unloading guides 129A,129B cooperate with the chuck assembly 117 to discharge the can ends 101A,101B from the rotary liner 113 after they have been suitably lined with the aforementioned sealant. The example rotary liner 113 includes a first unloading guide 129A and a second unloading guide 129B, although it will be appreciated that any known or suitable alternative number (e.g., one; three or more) (not shown) of unloading guides (e.g., 129A,129B) could be employed in any suitable alternative configuration (not shown), without departing from the scope of the disclosed concept. It will also be appreciated that conveying assembly embodiments having any known or suitable alternative plurality and/or configuration of downstackers (e.g., 123A,123B), star wheels (e.g., 125A,125B), fluid dispensing apparatus 121 (FIG. 5), and chuck members 127 fall within the scope of the disclosed concept.

As shown in FIG. 6, the first and second star wheels 125A,125B are preferably disposed in a spaced apart relationship on opposing sides of the aforementioned planar member 133 of the chuck assembly 117 such that the planar member 133 is generally disposed therebetween. The first unloading guide 129A is preferably disposed adjacent to the second star wheel 125B, and the second unloading guide 129B is preferably disposed adjacent to the first star wheel 125A. The first unloading guide 129A discharges can ends 101A, which were originally fed into the rotary liner 113 from the first downstacker 123A, and the second unloading guide 129B discharges can ends 101B originally fed into the rotary liner 113 from the second downstacker 123B, with the can ends 101A being discharged at or about the second side 137 of the base 115 of the rotary liner 113 and the can ends 101B being discharged at or about the first side 135 of the base 115.

The first unloading guide 129A includes a first guide portion 139 and a second guide portion 141 each of which is a single piece or component in the example shown and described herein. The first guide portion 139 includes first and second sides 147,149. The first side 147 of the first guide portion 139 of the first unloading guide 129A is disposed opposite and spaced apart from the second guide portion 141 of the first unloading guide 129A to form a discharge passageway 155 therebetween. The second side 149 of the first guide portion 139 is configured to cooperate with the second star wheel 125B to guide the can ends 101B from the second downstacker 123B to the chuck members 127 along the second pathway 131B. The second unloading guide 129B guides the can ends 101A along the first pathway 131A in substantially the same manner, as shown. Specifically, the first side 151 of the first guide portion 143 of the second unloading guide 129B is disposed opposite and spaced apart from the second guide portion 145 of the second unloading guide 129B, in a order to form a discharge passageway 157 therebetween. The second side 153 of the first guide portion 143 of the second unloading guide 129B cooperates with the first star wheel 125A to guide the container closures 101B from the second downstacker 123B to the chuck members 127 of the chuck assembly 117 and along pathway 131A, as shown.

Accordingly, it will be appreciated that the disclosed conveying assembly 100 establishes two distinct pathways 131A,131B for conveying can ends 101A,101B to and from the rotary liner 113, in order to increase the productivity thereof. More specifically, in the example shown and described herein, as the turret assembly 119 (FIG. 5) rotates about its axis 159, sixteen can ends 101A,101B are suitably lined with sealant (see, for example, sealant 5 of FIGS. 1A and 1B) during each revolution of the turret assembly 119. Thus, it will be appreciated that the rotary liner 113 may appropriately be referred to as a “two-in, two-out” rotary liner 113. That is, two can ends 101A and 101B are inserted into the liner 113 at substantially the same time by downstackers 123A and 123B, respectively, and two can ends 101A and 101B are discharged out of the liner 113 at substantially the same time by unloading guides 129A and 129B, respectively. The increase in productivity that is afforded by the disclosed rotary liner 113 and conveying assembly 100 therefor, will be further appreciated with reference to the non-limiting example set forth in Table 1 hereinbelow.

TABLE 1
ROTARY LINER PRODUCTIVITY

| END | EXISTING ROTARY | 2-IN & 2-OUT ROTARY |
|---|---|---|
| SIZE | LINER (epm) | LINER (epm) |
| 202 | 2100 | 3000 |
| 209 | 2000 | 2800 |
| 211 | 2000 | 2560 |
| 300 | 1350 | 2400 |
| 307 | 1250 | 2160 |

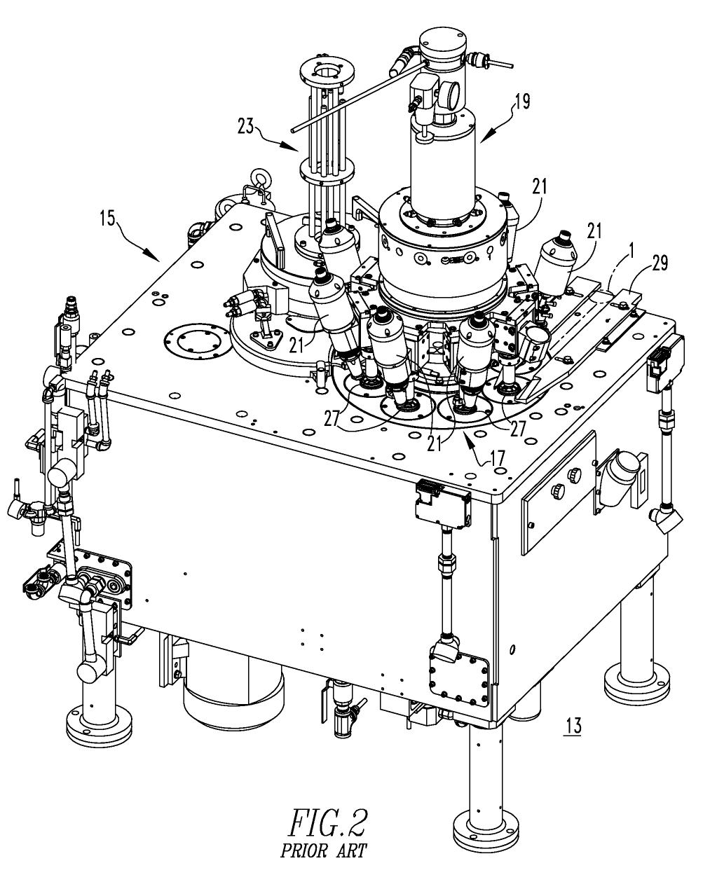

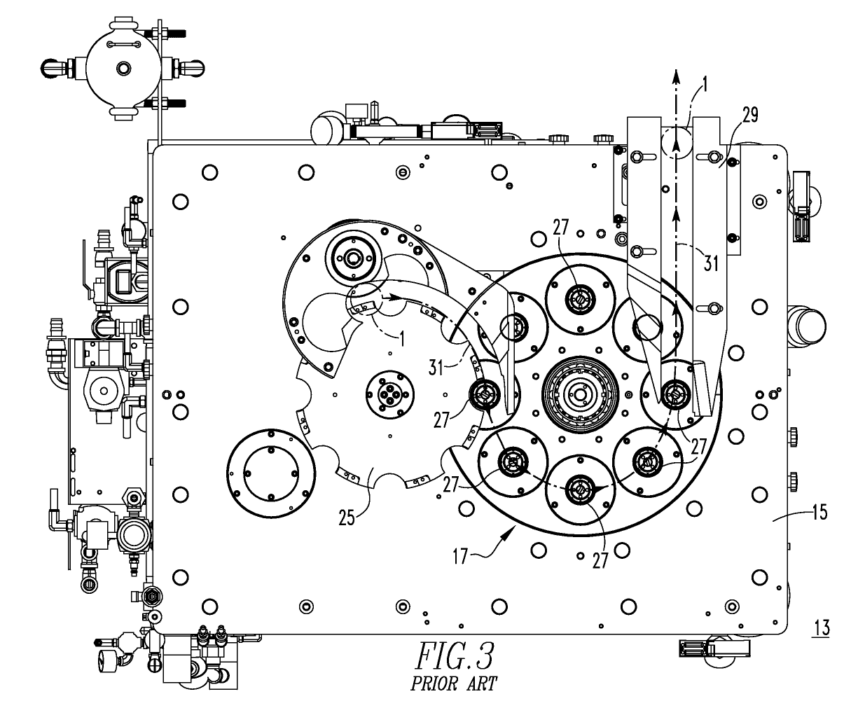

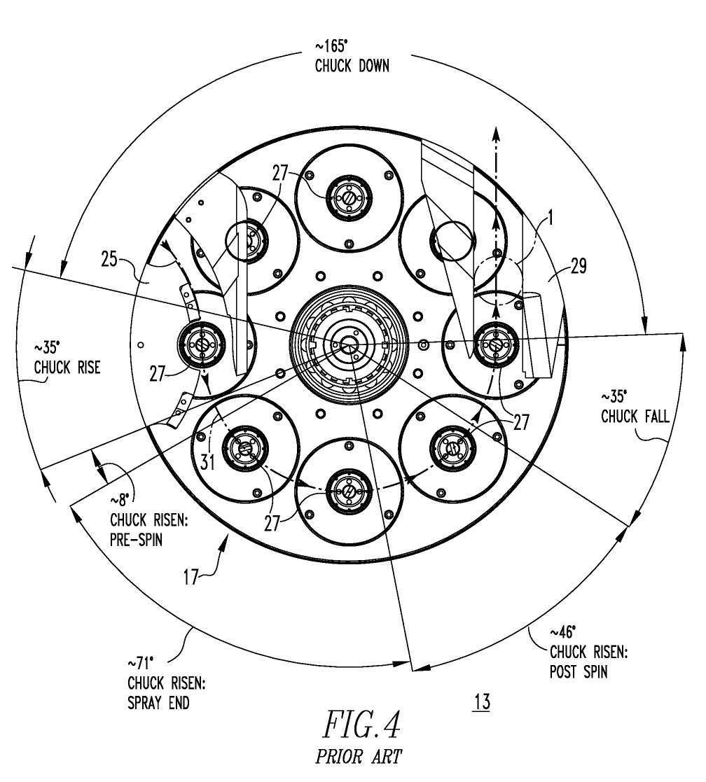

As shown in Table 1, the productivity of the disclosed rotary liner 113 is increased between about 40 percent and about 78 percent, depending on the size (e.g., without limitation, diameter) of the can end (e.g., 101A,101B) that is being lined, as compared to existing rotary liners (see, for example, rotary liner 113 of FIGS. 2-4). It is noted that, while the productivity increase of the disclosed rotary liner 113 compared to the conventional single downstacker, single star wheel design of, for example FIGS. 2-4, is substantial, it is less than double. This is because the rotational speed of the turret assembly 119 (FIG. 5) must be reduced in comparison, for example, to the rotational speed of the conventional turret assembly 19 of FIG. 2, in order to properly synchronize the downstackers 123A,123B, star wheels 125A,125B and chuck assembly 117, and to allow sufficient time (e.g., spray time) to adequately apply the sealant (see, for example, sealant 5 of FIGS. 1A and 1B) to each can end (e.g., 101A,101B). This reduction in speed is necessitated by the fact that the can ends 101A,101B remain on the chuck members 127 of the chuck assembly 117 for less time (e.g., less arcuate distance along respective pathway 131A,131B) than in the conventional design. This distinction will be further appreciated with comparison of FIG. 7 to prior art FIG. 4, which respectively show the system timing of the disclosed rotary liner 113 versus the conventional rotary liner 13. It will also be appreciated with reference to Table 2 hereinbelow.

Table 2 shows the timing and associated rotation of the turret assembly 119 (FIG. 5) illustrated in FIG. 7 for lining 202 can ends 101A,101B. It will be appreciated that it is provided for purposes of illustration only and is not meant to be limiting on the scope of the disclosed concept. For example, the timing and associated turret rotations will be different when lining can ends having a size other than 202.

TABLE 2
NEW VS. EXISTING 202 ROTARY LINER TIMING

| | |
|---|---|
| EXISTING | NEW |
| LINER TIMING | LINER TIMING |

| | Turret | Time | Turret | Time |
|---|---|---|---|---|
| | Degrees | (ms) | Degrees | (ms) |
| Chuck Rise | 35.0 | 22.2 | 18.0 | 16.0 |
| Chuck Risen: Pre- | 8.0 | 5.1 | 6.0 | 5.3 |
| Spin | | | | |
| Chuck Risen: | 71.0 | 45.1 | 51.0 | 45.3 |
| Spray End | | | | |
| Chuck Risen: Post | 46.0 | 29.2 | 15.0 | 13.3 |
| Spin | | | | |
| Chuck Fall | 35.0 | 22.2 | 18.0 | 16.0 |
| Chuck Down | 165.0 | 104.8 | 72.0 | 64.0 |
| Total | 360.0 | 228.6 | 180.0 | 160.0 |
| Turret Speed | 262.5 | Rpm | 187.5 | rpm |

Slowing the turret assembly 119 (FIG. 5) to a slower speed, as discussed above and as reflected in Table 2, also provides a number of benefits. For example, in addition to providing ample time to properly apply the sealant to the can end (e.g., 101A,101B), it also reduces the rotational speed of the star wheels 125A,125B, which lowers the force the star wheels 125A,125B apply to the can ends 101A,101B when manipulating them, and thereby reducing the propensity for the star wheels 125A,125B to damage (e.g., deform; dent; bend) the can ends 101A,101B, as was known to occur in the prior art. Additionally, the reduced rotational speed allows for an enlarged turret assembly 119 (FIG. 5) and/or chuck assembly 117 to be implemented (not shown). For example and without limitation, the diameter of the planar member (e.g., 133) can be increased (not shown) and the number of chuck members (e.g., 127) disposed thereon can be increased (not shown), thereby even further increasing the productivity of the liner 113. Accordingly, it will be appreciated that while the example embodiment shown and described herein has eight chuck members 127, it could have more or less than eight chuck members, without departing from the scope of the disclosed concept.

Referring to Table 2, it is interesting to note that the spray time is substantially similar for both rotary liners 13 (FIGS. 2-4), 113 (FIGS. 5-7). This is because the complete can end lining procedure requires approximately the same amount of time using either method. However, the amount of post spin time is significantly reduced, from about 29.2 ms (about 46 degrees) to about 13.3 ms (about 15 degrees), for the example of a 202 can end. It will be appreciated that the values presented in Tables 1 and 2 herein, are provided for illustrative purposes only and are not meant to be limiting upon the scope of the disclosed concept. Similarly, it will be appreciated that the angles (e.g., turret assembly rotation values) shown in the example of FIG. 7 merely represent one illustrative embodiment in accordance with the disclosed concept, and are not limiting.

Accordingly, a conveying assembly 100 and associated method for a rotary liner 113 are disclosed for lining a plurality (e.g., without limitation, at least one can end 101A from the first downstacker 123A, and at least one can end 101B from the second downstacker 101B) with sealant 5 (see, for example, FIGS. 1A and 1B) during a single revolution of the turret assembly 119 (FIG. 5), such that productivity of the rotary liner 113 is substantially improved.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A conveying assembly for conveying container closures to and from a rotary liner, said rotary liner including a base, a chuck assembly and a turret assembly, said turret assembly including a number of fluid dispensing apparatus structured to dispense a sealant for lining said container closures, said chuck assembly comprising a plurality of chuck members structured to manipulate said container closures with respect to said fluid dispensing apparatus to facilitate the application of said sealant, said conveying assembly comprising:
a plurality of downstackers structured to feed said container closures into said rotary liner;
a plurality of star wheels each being structured to transfer a number of said container closures from a corresponding one of said downstackers to said chuck assembly; and
a number of unloading guides structured to cooperate with said chuck assembly to discharge said container closures from said rotary liner.

2. The conveying assembly of claim 1 wherein said plurality of downstackers is a first downstacker and a second downstacker; wherein said plurality of star wheels is a first star wheel and a second star wheel; wherein said first star wheel is structured to transfer each of said container closures from said first downstacker to a corresponding one of said chuck members of said chuck assembly; and wherein said second star wheel is structured to transfer each of said container closures from said second downstacker to another corresponding one of said chuck members of said chuck assembly.

3. The conveying assembly of claim 2 wherein said chuck assembly further comprises a planar member movably coupled to the base of said rotary liner; wherein said chuck members are disposed on said planar member; and wherein said second star wheel is disposed opposite and distal from said first star wheel with said planar member being generally disposed therebetween.

4. The conveying assembly of claim 2 wherein said number of unloading guides is a first unloading guide and a second unloading guide; wherein said first unloading guide is disposed adjacent to said second star wheel; and wherein said second unloading guide is disposed adjacent to said first star wheel.

5. The conveying assembly of claim 4 wherein the base of said rotary liner includes a first side and a second side disposed opposite and distal from the first side; wherein said first unloading guide is structured to discharge the container closures fed into said rotary liner from said first downstacker; wherein the second unloading guide is structured to discharge the container closure fed into said rotary liner from said second downstacker; wherein said first unloading guide is structured to discharge said container closures at or about the second side of the base of said rotary liner; and wherein said second unloading guide is structured to discharge said container closures at or about the first side of the base of said rotary liner.

6. The conveying assembly of claim 1 wherein each of said unloading guides comprises a first guide portion and a second guide portion; wherein the first guide portion includes a first side and a second side; wherein the first side of the first guide portion is disposed opposite and spaced apart from the second guide portion to form a discharge passageway therebetween; and wherein the second side of the first guide portion is structured to cooperate with a corresponding one of said star wheels to guide said container closures from said corresponding one of said downstackers to said chuck members of said chuck assembly.

7. The conveying assembly of claim 1 wherein said turret assembly rotates about an axis; and wherein a plurality of container closures are lined with said sealant during each revolution of said turret assembly about said axis.

8. A rotary liner comprising:
a base including a first side and a second side;
a turret assembly including a number of fluid dispensing apparatus structured to dispense a sealant for lining a plurality of container closures;
a chuck assembly comprising a plurality of chuck members for manipulating said container closures with respect to said fluid dispensing apparatus to facilitate the application of said sealant; and
a conveying assembly for conveying said container closures to and from said rotary liner, said conveying assembly comprising:
a plurality of downstackers for feeding said container closures into said rotary liner,
a plurality of star wheels each transferring a number of said container closures from a corresponding one of said downstackers to corresponding chuck members of said chuck assembly, and
a number of unloading guides cooperating with said chuck assembly to discharge said container closures from the first side of the base of said rotary liner and the second side of the base of said rotary liner.

9. The rotary liner of claim 8 wherein said plurality of downstackers of said conveying assembly is a first downstacker and a second downstacker; wherein said plurality of star wheels of said conveying assembly is a first star wheel and a second star wheel; wherein said first star wheel transfers each of said container closures from said first downstacker to a corresponding one of said chuck members of said chuck assembly; and wherein said second star wheel transfers each of said container closures from said second downstacker to another corresponding one of said chuck members of said chuck assembly.

10. The rotary liner of claim 9 wherein said chuck assembly further comprises a planar member movably coupled to the base of said rotary liner; wherein said chuck members are disposed on said planar member; wherein said second star wheel of said conveying assembly is disposed opposite and distal from said first star wheel of said conveying assembly; and wherein said planar member of said chuck assembly is generally disposed between said first star wheel and said second star wheel.

11. The rotary liner of claim 10 wherein said number of unloading guides of said conveying assembly is a first unloading guide and a second unloading guide; wherein said first unloading guide is disposed adjacent to said second star wheel; and wherein said second unloading guide is disposed adjacent to said first star wheel.

12. The rotary liner of claim 11 wherein said first unloading guide discharges the container closures fed into said rotary liner from said first downstacker; wherein the second unloading guide discharges the container closured fed into said rotary liner from said second downstacker; wherein said first unloading guide discharges said container closures at or about the second side of the base; and wherein said second unloading guide discharges said container closures at or about the first side of the base.

13. The rotary liner of claim 8 wherein each of said unloading guides of said conveying assembly comprises a first guide portion and a second guide portion; wherein the first guide portion includes a first side and a second side; wherein the first side of the first guide portion is disposed opposite and spaced apart from the second guide portion to form a discharge passageway therebetween; and wherein the second side of the first guide portion cooperates with a corresponding one of said star wheels of said conveying assembly to guide said container closures from said corresponding one of said downstackers to said chuck members of said chuck assembly.

14. The rotary liner of claim 8 wherein said turret assembly rotates about an axis; and wherein said rotary liner lines a plurality of said container closures with said sealant during each revolution of said turret assembly about said axis.

15. A method of lining container closures in a rotary liner, the method comprising:
providing a conveying assembly including a first downstacker, a second downstacker, a first star wheel and a second star wheel;
feeding a number of container closures from said first downstacker and a number of container closures from said second downstacker into said rotary liner;
transferring each of said container closures from said first downstacker to a corresponding chuck member of a chuck assembly of said rotary liner using said first star wheel;
transferring each of said container closures from said second downstacker to another corresponding chuck member of said chuck assembly using said second star wheel;
rotating a turret assembly of said rotary liner about an axis and dispensing a sealant as said turret assembly rotates;
lining a plurality of container closures from said first downstacker and a plurality of container closures from said second downstacker with said sealant during a single revolution of said turret assembly about said axis; and
discharging said container closures from a number of unloading guides of said rotary liner.

16. The method of claim 15 wherein said step of lining said container closures further comprises:
rotating said container closures on said corresponding chuck members to smooth out said sealant.

17. The method of claim 15 wherein said number of unloading guides of said rotary liner comprises a first unloading guide and a second unloading guide; and wherein said step of discharging said container closures further comprises:
discharging said container closures originating from said first downstacker from said first unloading guide, and
discharging said container closures originating from said second downstacker from said second unloading guide.
